(19) United States
(12) Patent Application Publication
(10) Pub. No.: US 2026/0323692 A1
(43) Pub. Date: Oct. 15, 2026

(54) COMMUNICATION METHOD AND APPARATUS, DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/880,923

(22) PCT Filed: Jul. 6, 2022
(86) PCT No.: PCT/CN2022/104241

§ 371 Date: Jan. 3, 2025

(51) Int. Cl. H04W 74/0816; H04L 5/00; H04W 74/06; H04W 84/12

(52) U.S. Cl. CPC H04W 74/0816; H04L 5/0053; H04W 74/06; H04W 84/12

(57) ABSTRACT

A communication method, performed by a sensing by proxy (SBP) responding device, including: receiving a first message frame, wherein the first message frame indicates that an SBP report frame is to be transmitted; and transmitting the SBP report frame.

### CROSS-REFERENCE TO RELATED APPLICATION

This application is the U.S. national phase application of International Application No. PCT/CN 2022/104241, filed on Jul. 6, 2022, the disclosure of which is incorporated herein by reference in its entirety for all purposes.

### TECHNICAL FIELD

Examples of the present disclosure relate to the field of communication technologies. Particularly, the examples of the present disclosure relate to a communication method, apparatus, device, and storage medium.

### BACKGROUND

With the rapid development of mobile communication technologies, wireless fidelity (Wi-Fi) technologies have made great progress in terms of transmission rate and throughput.

For the Wi-Fi technologies currently being studied, wireless local area network (WLAN) sensing technologies may be supported, e.g., in application scenarios such as location discovery, proximity detection, and presence detection in a dense environment (such as a home environment or a company environment). In a WLAN sensing procedure, either a station device (STA) or an access point device (AP) may act as an initiating device. The AP may communicate with a plurality of STAs simultaneously, whereas the STA has no such capability and can only communicate one-to-one with a single responding device. Therefore, a scheme of initiating a sensing measurement by the AP as a proxy of the STA is proposed. However, a process of transmitting an SBP report frame from the AP proxy to the STA has not yet been settled.

### SUMMARY

Examples of the present disclosure provide a communication method, apparatus, device, and storage medium, which may provide a process of transmitting a sensing before proxy (SBP) report frame from an SBP responding device to an SBP initiating device.

In a first aspect, the examples of the present disclosure provide a communication method, performed by an SBP responding device, and the method includes: receiving a first message frame, wherein the first message frame indicates that an SBP report frame is to be transmitted; and transmitting the SBP report frame.

In a second aspect, the examples of the present disclosure provide a communication method, performed by an SBP initiating device, and the method includes: transmitting a first message frame, wherein the first message frame indicates that an SBP report frame is to be transmitted; and receiving the SBP report frame.

In a third aspect, the examples of the present disclosure further provide an SBP responding device, including one or more memories, one or more processors, and a computer program stored in the one or more memories and executable on the one or more processors. The one or more processors, when executing the program, are configured to: receive a first message frame, wherein the first message frame indicates that an SBP report frame is to be transmitted; and transmit the SBP report frame.

The examples of the present disclosure provide a process of transmitting the SBP report frame from the SBP responding device to the SBP initiating device.

For the additional aspects and advantages of the present disclosure, a part of them will be set forth in the following description, which will be apparent according to the following description or be learned through putting the present disclosure into practice.

### BRIEF DESCRIPTION OF THE DRAWINGS

The drawings to be used by the description of the examples of the present disclosure will be briefly introduced to explain the technical solutions provided in examples of the present disclosure more clearly. It is obvious that, the drawings in the following description illustrate only some examples of the present disclosure, and based on these drawings, those of ordinary skill in the art may obtain other drawings without creative work.

FIG. 1 is a schematic diagram of a WLAN sensing measurement architecture provided in an example of the present disclosure.

FIG. 2 is a schematic diagram of communication connections provided in an example of the present disclosure.

FIG. 3 is a schematic diagram of another WLAN sensing measurement architecture provided in an example of the present disclosure.

FIG. 4 is a schematic flowchart of a communication method provided in an example of the present disclosure.

FIG. 5 is a first schematic flowchart of transmitting an SBP report frame provided in an example of the present disclosure.

FIG. 6A is a second schematic flowchart of transmitting an SBP report frame provided in an example of the present disclosure.

FIG. 6B is a third schematic flowchart of transmitting an SBP report frame provided in an example of the present disclosure.

FIG. 6C is a fourth schematic flowchart of transmitting an SBP report frame provided in an example of the present disclosure.

FIG. 7 is a fifth schematic flowchart of transmitting an SBP report frame provided in an example of the present disclosure.

FIG. 8A is a sixth schematic flowchart of transmitting an SBP report frame provided in an example of the present disclosure.

FIG. 8B is a seventh schematic flowchart of transmitting an SBP report frame provided in an example of the present disclosure.

FIG. 8C is an eighth schematic flowchart of transmitting an SBP report frame provided in an example of the present disclosure.

FIG. 9 is a schematic flowchart of another communication method provided in an example of the present disclosure.

FIG. 10 is a schematic structural diagram of a communication apparatus provided in an example of the present disclosure.

FIG. 11 is a schematic structural diagram of another communication apparatus provided in an example of the present disclosure.

FIG. 12 is a schematic structural diagram of an electronic device provided in an example of the present disclosure.

### DETAILED DESCRIPTION OF THE EMBODIMENTS

The term “and/or” in the examples of the present disclosure describes association relationships between associated objects, indicating that there can be three types of relationships. For example, A and/or B means that A exists alone, A and B exist at the same time, and B exists alone. The character “/” generally indicates that the associated objects before and after are in an “or” relationship.

The term “plurality” in the examples of the present disclosure refers to two or more than two, and other quantifiers are similar thereto.

Examples will be described in detail herein, whose instances are illustrated in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a,” “said” and “the” in their singular forms in the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be used in the present disclosure to describe various information, such information should not be limited to these terms. These terms are only used to distinguish the information of the same type with each other. For example, without departing from the scope of the present disclosure, first information may be referred to as second information; and similarly, second information may also be referred to as first information. Depending on the context, the word “if” as used herein may be interpreted as “when,” “upon,” or “in response to determining.”

The following, in conjunction with the drawings of the examples of the present disclosure, will clearly and completely describe the technical solutions provided in the examples of the present disclosure. It is obvious that the described examples are a part, but not all, of the examples of the present disclosure. Based on the examples of the present disclosure, all of other examples, which can be obtained by those of ordinary skill in the art without creative work, shall fall within the protection scope of the present disclosure.

The methods and the apparatuses are based on the same disclosed concept. The implementations of the methods and the apparatuses can refer to each other since their principles of solving problems are similar and their repeated parts are not to be repeated.

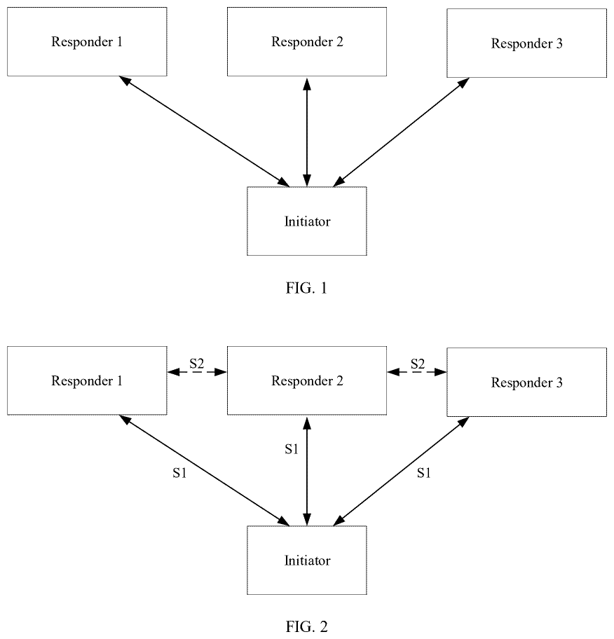

As a first example, referring to FIG. 1 to FIG. 3, wireless local area network (WLAN) sensing measurement architectures and WLAN sensing measurement procedures to which communication methods provided in the examples of the present disclosure are applied are first introduced.

FIG. 1 illustrates a schematic diagram of a WLAN sensing measurement architecture. A sensing initiator initiates a WLAN sensing measurement (e.g., initiates a WLAN sensing measurement session). There may be a plurality of sensing responders responding thereto, as illustrated by Responder 1, Responder 2, and Responder 3 in FIG. 1. When the sensing initiator initiates the WLAN sensing measurement, the plurality of associated or unassociated sensing responders of the WLAN sensing measurement may perform the response.

Being “associated” here may refer to that an initial association connection for communications has been established between the sensing initiator and the sensing responder, and being “unassociated” may refer to that no initial association connection for communications has been established between the sensing initiator and the sensing responder.

Referring to FIG. 2, the sensing initiator communicates with the sensing responders via communication connections, as illustrated by communication connection S1, and the sensing responders communicate with each other via communication connections S2.

Each sensing initiator may be a client, and each sensing responder (i.e., Sensing Responder 1 to Sensing Responder 3 in the example) may be a station device (STA) or an access point device (AP). In addition, the STA and the AP may play multiple roles in the WLAN sensing measurement procedure. For example, the STA may also act as the sensing initiator in the WLAN sensing measurement procedure. The sensing initiator may be a sensing transmitter, a sensing receiver, or both, or neither. The sensing responder may be the sensing transmitter, the sensing receiver, or both in the WLAN sensing measurement procedure.

The AP is a wireless switch used in a wireless network and is also an access device for the wireless network. The AP may include software applications and/or circuits to enable other types of nodes in the wireless network to communicate externally and internally to the wireless network through the AP. For example, the AP may be a terminal device or a network device equipped with a wireless fidelity (Wi-Fi) chip.

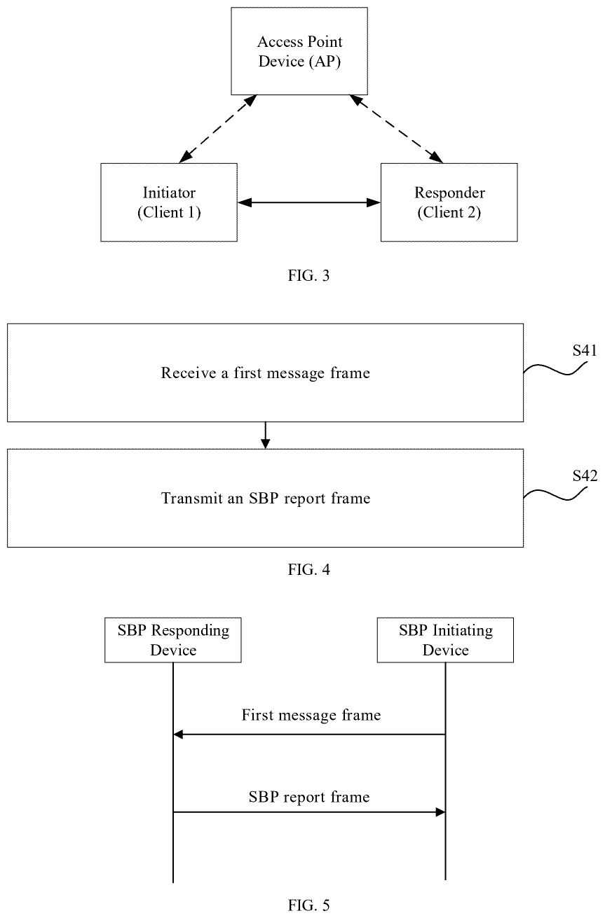

As another architecture, as illustrated in FIG. 3, the sensing initiator and the sensing responder may be both clients, and the two may communicate by connecting to the same AP. In FIG. 3, Client 1 is the sensing initiator, and Client 2 is the sensing responder.

For implementing one-to-many communications between the STA acting as the sensing initiator and the sensing responders in the WLAN sensing measurement procedure, the STA acting as a sensing by proxy (SBP) initiator (which is described by taking an SBP initiating device as an example below) initiates an SBP procedure, the AP acting as an SBP responder (which is described by taking an SBP responding device as an example below) serves as a proxy of the STA to perform the WLAN sensing measurement.

The SBP initiating device and the SBP responding device may include, but are not limited to, cellular phones, smart phones, wearable devices, computers, personal digital assistants (PDAs), personal communication system (PCS) devices, personal information managers (PIMs), personal navigation devices (PNDs), global positioning systems, multimedia devices, Internet of Things (IoT) devices, etc.

A communication method provided in an example of the present disclosure may be specifically referred to in FIG. 4, which is a schematic flowchart of the communication method provided in the example of the present disclosure. Alternatively, or additionally, the method may be applied to an SBP responding device. The SBP responding device may be an AP. The method may include the following steps.

At step S41, a first message frame is received.

The first message frame is a message frame that is transmitted by an SBP initiating device and indicates the SBP responding device to transmit one or more SBP reports.

At step S42, an SBP report frame is transmitted.

After receiving the first message frame transmitted by the SBP initiating device, the SBP responding device transmits the SBP report frame to the SBP initiating device.

For example, as illustrated in FIG. 5, the SBP responding device receives the first message frame transmitted by the SBP initiating device, and then transmits the SBP report frame to the SBP initiating device.

In one or more communication methods applied to the SBP responding device provided in the present disclosure, the first message frame is a clear to send (CTS)-to-self frame, a power save (PS)-Poll frame or an SBP report request frame.

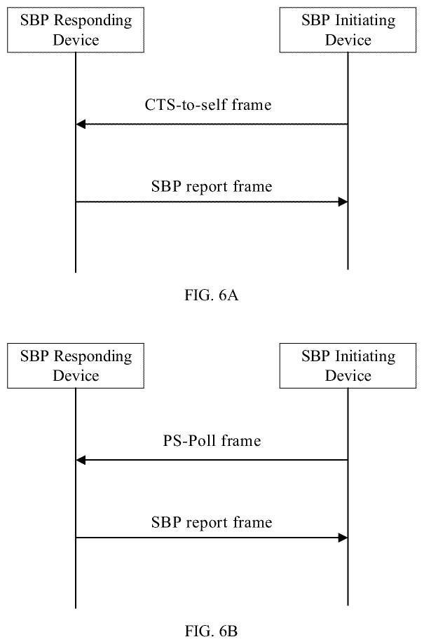

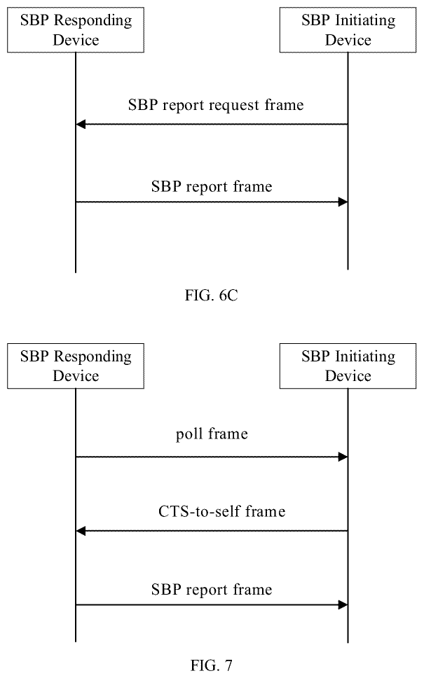

As an example, as illustrated in FIG. 6A, the first message frame is the CTS-to-self frame. After receiving the CTS-to-self frame, the SBP responding device transmits the SBP report frame to the SBP initiating device.

As an example, as illustrated in FIG. 6B, the first message frame is the PS-Poll frame. After receiving the PS-Poll frame, the SBP responding device transmits the SBP report frame to the SBP initiating device.

As an example, as illustrated in FIG. 6C, the first message frame is the SBP report request frame. After receiving the SBP report request frame, the SBP responding device transmits the SBP report frame to the SBP initiating device.

In one or more communication methods applied to the SBP responding device provided in the present disclosure, when the first message frame is the CTS-to-self frame and before the SBP responding device receives the first message frame, the method further includes:
transmitting a poll frame, where the poll frame requests a trigger for transmitting the SBP report frame.

As illustrated in FIG. 7, the SBP responding device transmits the poll frame to the SBP initiating device to request the trigger of the SBP initiating device for transmitting the SBP report frame. After receiving the CTS-to-self frame transmitted by the SBP initiating device, the SBP responding device transmits the SBP report frame to the SBP initiating device.

In one or more communication methods applied to the SBP responding device provided in the present disclosure, when the first message frame is the PS-Poll frame and before the SBP responding device transmits the SBP report frame, the method further includes:
transmitting a second message frame, where the second message frame indicates a confirmation of transmitting the SBP report frame.

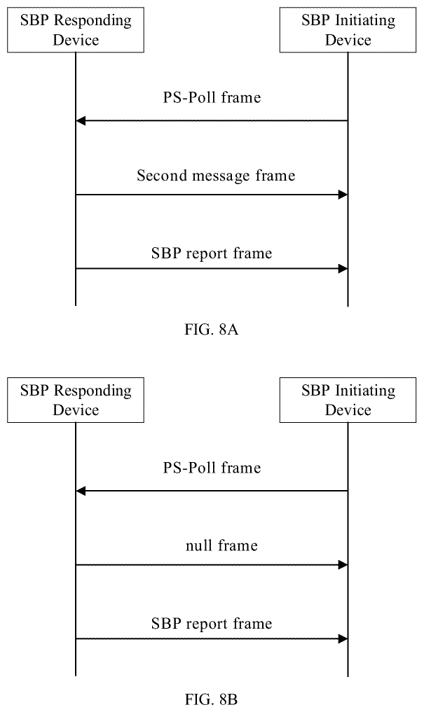

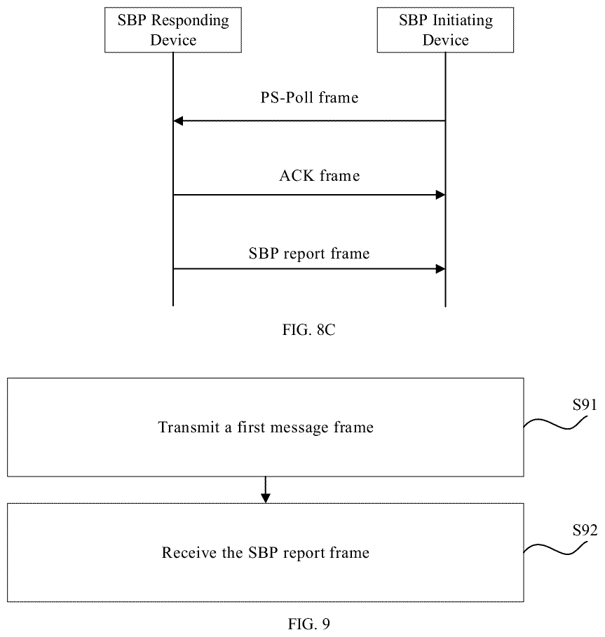

As illustrated in FIG. 8A, after receiving the PS-Poll frame transmitted by the SBP initiating device, the SBP responding device transmits the second message frame to the SBP initiating device, so as to indicate the SBP initiating device the confirmation of the SBP responding device of transmitting the SBP report frame, and then transmits the SBP report frame to the SBP initiating device after transmitting the second message frame.

In one or more communication methods applied to the SBP responding device provided in the present disclosure, the second message frame transmitted from the SBP responding device to the SBP initiating device is a null frame or an acknowledgement (ACK) frame.

As an example, as illustrated in FIG. 8B, after receiving the PS-Poll frame transmitted by the SBP initiating device, the SBP responding device transmits the null frame to the SBP initiating device, so as to indicate the SBP initiating device the confirmation of the SBP responding device of transmitting the SBP report frame, and then transmits the SBP report frame to the SBP initiating device after transmitting the second message frame.

As an example, as illustrated in FIG. 8C, after receiving the PS-Poll frame transmitted by the SBP initiating device, the SBP responding device transmits the ACK frame to the SBP initiating device, so as to indicate the SBP initiating device the confirmation of the SBP responding device of transmitting the SBP report frame, and then transmits the SBP report frame to the SBP initiating device after transmitting the second message frame.

In one or more communication methods applied to the SBP responding device provided in the present disclosure, when the first message frame is the SBP report request frame, the first message frame includes a WLAN sensing measurement setup identifier assigned by the SBP responding device to the SBP initiating device. The WLAN sensing measurement setup identifier indicates the SBP report frame of the WLAN sensing measurement procedure corresponding to the WLAN sensing measurement setup identifier to be transmitted, i.e., indicates one or more sensing measurement results of the WLAN sensing measurement procedure corresponding to the WLAN sensing measurement setup identifier to be transmitted.

In one or more communication methods applied to the SBP responding device provided in the present disclosure, the SBP report frame transmitted from the SBP responding device to the SBP initiating device includes the WLAN sensing measurement setup identifier allocated by the SBP responding device to the SBP initiating device. The WLAN sensing measurement setup identifier indicates the WLAN sensing measurement procedure corresponding to the SBP report frame.

That is, in a case that a plurality of SBP sensing measurement procedures are established between the SBP responding device and the SBP initiating device, the SBP report frame may indicate its corresponding WLAN sensing measurement procedure through the WLAN sensing measurement setup identifier it carries, i.e., indicates the WLAN sensing measurement procedure corresponding to the one or more sensing measurement results included in the SBP report frame.

In one or more communication methods applied to the SBP responding device provided in the present disclosure, the SBP responding device transmits the SBP report frame to the SBP initiating device, which includes:
transmitting the SBP report frame within a first time interval.

The first time interval is determined by the SBP responding device and the SBP initiating device in the WLAN sensing measurement setup procedure.

The first time interval may also be specified by either the SBP responding device or the SBP initiating device in the WLAN sensing measurement setup procedure, which is not limited here.

In one or more communication methods applied to the SBP responding device provided in the present disclosure, each of the time intervals for the SBP responding device to receive the first message frame, to transmit the second message frame, and to transmit the poll frame may be determined by the SBP responding device and/or the SBP initiating device in the WLAN sensing measurement setup procedure.

In one or more communication methods applied to the SBP responding device provided in the present disclosure, in a case that the SBP initiating device does not participate in an WLAN sensing measurement, the SBP report frame includes the sensing measurement results of all STAs participating in the WLAN sensing measurement; and in a case that the SBP initiating device participates in the WLAN sensing measurement, the SBP report frame does not include the sensing measurement result of the SBP initiating device itself, that is, the SBP responding device is not expected to transmit the sensing measurement result of the SBP initiating device itself to the SBP initiating device.

The examples of the present disclosure provide a plurality of processes of transmitting the SBP report frame from the SBP responding device to the SBP initiating device.

A communication method provided in an example of the present disclosure may be specifically referred to FIG. 9, which is another schematic flowchart of the communication methods provided in the examples of the present disclosure. Alternatively, or additionally, the method may be applied to an SBP initiating device. The SBP initiating device may be an STA. The method may include the following steps.

At step S91, a first message frame is transmitted.

The SBP initiating device may transmit the first message frame to an SBP responding device, so as to indicate the SBP responding device to transmit an SBP report frame.

At step S92, the SBP report frame is received.

After transmitting the first message frame to the SBP responding device, the SBP initiating device may receive the SBP report frame transmitted by the SBP responding device.

In one or more communication methods applied to the SBP initiating device provided in the present disclosure, the first message frame is a CTS-to-self frame, a PS-Poll frame or an SBP report request frame.

As an example, the first message frame is the CTS-to-self frame. The SBP initiating device transmits the CTS-to-self frame to the SBP responding device, so as to indicate the SBP responding device to transmit the SBP report frame, and receives the SBP report frame transmitted by the SBP responding device.

As an example, the first message frame is the PS-Poll frame. The SBP initiating device transmits the PS-Poll frame to the SBP responding device, so as to indicate the SBP responding device to transmit the SBP report frame, and receives the SBP report frame transmitted by the SBP responding device.

As an example, the first message frame is the SBP report request frame. The SBP initiating device transmits the SBP report request frame to the SBP responding device, so as to indicate the SBP responding device to transmit the SBP report frame, and receives the SBP report frame transmitted by the SBP responding device.

In one or more communication methods applied to the SBP initiating device provided in the present disclosure, when the first message frame is the CTS-to-self frame and before the SBP initiating device transmits the first message frame, the method further includes:
receiving a poll frame, where the poll frame requests a trigger for transmitting the SBP report frame.

That is, the SBP initiating device receives the poll frame transmitted by the SBP responding device for requesting the trigger of the SBP initiating device for transmitting the SBP report frame, transmits the CTS-to-self frame to the SBP responding device after receiving the poll frame transmitted by the SBP responding device, and then receives the SBP report frame transmitted from the SBP responding device to the SBP initiating device.

In one or more communication methods applied to the SBP initiating device provided in the present disclosure, when the first message frame is the PS-Poll frame and before the SBP initiating device receives the SBP report frame, the method further includes:
receiving a second message frame, where the second message frame indicates a confirmation of transmitting the SBP report frame.

That is, after transmitting the PS-Poll frame to the SBP responding device, the SBP initiating device receives the second message frame transmitted by the SBP responding device, and receives the SBP report frame transmitted by the SBP responding device after receiving the second message frame.

In one or more communication methods applied to the SBP initiating device provided in the present disclosure, the second message frame received by the SBP initiating device is a null frame or an ACK frame.

As an example, after transmitting the PS-Poll frame to the SBP responding device, the SBP initiating device receives the null frame transmitted by the SBP responding device, so as to determine the confirmation of the SBP responding device of transmitting the SBP report frame, and then receives the SBP report frame transmitted by the SBP responding device after receiving the null frame.

As an example, after transmitting the PS-Poll frame to the SBP responding device, the SBP initiating device receives the ACK frame transmitted by the SBP responding device, so as to determine the confirmation of the SBP responding device of transmitting the SBP report frame, and then receives the SBP report frame transmitted by the SBP responding device after receiving the ACK frame.

In one or more communication methods applied to the SBP initiating device provided in the present disclosure, when the first message frame is the SBP report request frame, the first message frame includes a WLAN sensing measurement setup identifier assigned by the SBP responding device to the SBP initiating device. The WLAN sensing measurement setup identifier indicates the SBP report frame of a WLAN sensing measurement procedure corresponding to the WLAN sensing measurement setup identifier to be transmitted, i.e., indicates one or more sensing measurement results of the WLAN sensing measurement procedure corresponding to the WLAN sensing measurement setup identifier to be transmitted.

In one or more communication methods applied to the SBP initiating device provided in the present disclosure, the SBP report frame received by the SBP initiating device includes the WLAN sensing measurement setup identifier allocated by the SBP responding device to the SBP initiating device. The WLAN sensing measurement setup identifier indicates the WLAN sensing measurement procedure corresponding to the SBP report frame.

That is, in a case that a plurality of SBP sensing measurement procedures are established between the SBP responding device and the SBP initiating device, the SBP report frame may indicate its corresponding WLAN sensing measurement procedure through the WLAN sensing measurement setup identifier it carries, i.e., indicates the WLAN sensing measurement procedure corresponding to the one or more sensing measurement results included in the SBP report frame.

In one or more communication methods applied to the SBP initiating device provided in the present disclosure, the SBP initiating device receives the SBP report frame, which includes:
receiving the SBP report frame within a first time interval.

The first time interval is determined by the SBP responding device and the SBP initiating device in the WLAN sensing measurement setup procedure.

The first time interval may also be specified by either the SBP responding device or the SBP initiating device in the WLAN sensing measurement setup procedure, which is not limited here.

In one or more communication methods applied to the SBP initiating device provided in the present disclosure, each of the time intervals for the SBP initiating device to transmit the first message frame, to receive the second message frame, and to receive the poll frame may be determined by the SBP responding device and/or the SBP initiating device in the WLAN sensing measurement setup procedure.

In one or more communication methods applied to the SBP initiating device provided in the present disclosure, in a case that the SBP initiating device does not participate in an WLAN sensing measurement, the SBP report frame includes the sensing measurement results of all STAs participating in the WLAN sensing measurement; and in a case that the SBP initiating device participates in the WLAN sensing measurement, the SBP report frame does not include the sensing measurement result of the SBP initiating device itself, that is, the SBP responding device is not expected to transmit the sensing measurement result of the SBP initiating device itself to the SBP initiating device.

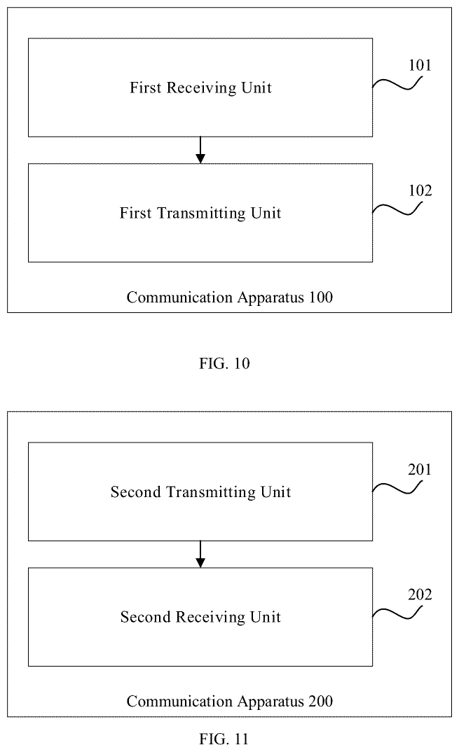

As illustrated in FIG. 10, an example of the present disclosure provides a communication apparatus 100, including:
a first receiving unit 101 that is configured to receive a first message frame, where the first message frame indicates that an SBP report frame is to be transmitted; and
a first transmitting unit 102 that is configured to transmit the SBP report frame.

Alternatively, or additionally, in one or more examples of the present disclosure, the first message frame is a CTS-to-self frame, a PS-Poll frame or an SBP report request frame.

Alternatively, or additionally, in one or more examples of the present disclosure, when the first message frame is the CTS-to-self frame and before receiving the first message frame, the first transmitting unit 102 is further configured to:
transmit a poll frame, where the poll frame requests a trigger for transmitting the SBP report frame.

Alternatively, or additionally, in one or more examples of the present disclosure, when the first message frame is the PS-Poll frame and before transmitting the SBP report frame, the first transmitting unit 102 is further configured to:
transmit a second message frame, where the second message frame indicates a confirmation of transmitting the SBP report frame.

Alternatively, or additionally, in one or more examples of the present disclosure, the second message frame is a null frame or an ACK frame.

Alternatively, or additionally, in one or more examples of the present disclosure, when the first message frame is the SBP report request frame, the first message frame includes a WLAN sensing measurement setup identifier allocated by an SBP responding device to an SBP initiating device.

Alternatively, or additionally, in one or more examples of the present disclosure, the SBP report frame includes the WLAN sensing measurement setup identifier allocated by the SBP responding device to the SBP initiating device.

Alternatively, or additionally, in one or more examples of the present disclosure, the first transmitting unit 102 is configured to:
transmit the SBP report frame within a first time interval, where the first time interval is determined by the SBP responding device and the SBP initiating device in a WLAN sensing measurement setup procedure.

Alternatively, or additionally, in one or more examples of the present disclosure, the SBP report frame includes sensing measurement results of all STAs participating in a WLAN sensing measurement in a case that the SBP initiating device does not participate in the WLAN sensing measurement, and does not include the sensing measurement result of the SBP initiating device in a case that the SBP initiating device participates in the WLAN sensing measurement.

As illustrated in FIG. 11, an example of the present disclosure provides a communication apparatus 200, including:
a second transmitting unit 201 that is configured to transmit a first message frame, where the first message frame indicates that an SBP report frame is to be transmitted; and
a second receiving unit 202 that is configured to receive the SBP report frame.

Alternatively, or additionally, in one or more examples of the present disclosure, the first message frame is a CTS-to-self frame, a PS-Poll frame or an SBP report request frame.

Alternatively, or additionally, in one or more examples of the present disclosure, when the first message frame is the CTS-to-self frame and before transmitting the first message frame, the second receiving unit 202 is further configured to:
receive a poll frame, where the poll frame requests a trigger for transmitting the SBP report frame.

Alternatively, or additionally, in one or more examples of the present disclosure, when the first message frame is the PS-Poll frame and before receiving the SBP report frame, the second receiving unit 202 is further configured to:
receive a second message frame, where the second message frame indicates a confirmation of transmitting the SBP report frame.

Alternatively, or additionally, in one or more examples of the present disclosure, the second message frame is a null frame or an ACK frame.

Alternatively, or additionally, in one or more examples of the present disclosure, when the first message frame is the SBP report request frame, the first message frame includes a WLAN sensing measurement setup identifier allocated by an SBP responding device to an SBP initiating device.

Alternatively, or additionally, in one or more examples of the present disclosure, the SBP report frame includes the WLAN sensing measurement setup identifier allocated by the SBP responding device to the SBP initiating device.

Alternatively, or additionally, in one or more examples of the present disclosure, the second receiving unit 202 is configured to:
receive the SBP report frame within a first time interval, where the first time interval is determined by the SBP responding device and the SBP initiating device in a WLAN sensing measurement setup procedure.

Alternatively, or additionally, in one or more examples of the present disclosure, the SBP report frame includes sensing measurement results of all STAs participating in a WLAN sensing measurement in a case that the SBP initiating device does not participate in the WLAN sensing measurement, and does not include the sensing measurement result of the SBP initiating device in a case that the SBP initiating device participates in the WLAN sensing measurement.

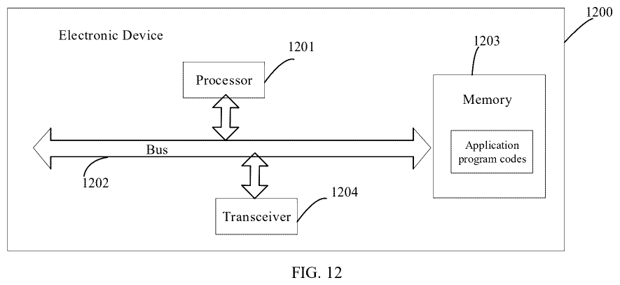

An example of the present disclosure further provides an electronic device, as illustrated in FIG. 12. The electronic device 1200 illustrated in FIG. 12 includes a processor 1201 and a memory 1203. The processor 1201 and the memory 1203 are connected, for example, via a bus 1202. Alternatively, or additionally, the electronic device 1200 may further include a transceiver 1204. It is to be noted that in actual applications, the number of transceivers 1204 is not limited to one, and the structure of the electronic device 1200 does not constitute a limitation on the example of the present disclosure.

The memory 1203 is configured to store application program codes for executing the examples of the present disclosure, and the execution is controlled by the processor 1201. When the electronic device 1200 acts as an SBP responding device, the processor 1201 is configured to execute the application program codes stored in the memory 1203 to implement the communication methods applicable to the SBP responding device in the present solutions. When the electronic device 1200 acts as an SBP initiating device, the processor 1201 is configured to execute the application program codes stored in the memory 1203 to implement the communication methods applicable to the SBP initiating device in the present solutions.

The bus 1202 may include a pathway for transmitting information between the above components. The bus 1202 may be a peripheral component interconnect (PCI) bus or an extended industry standard architecture (EISA) bus, etc. The bus 1202 may be divided into an address bus, a data bus, a control bus, and so on. For ease of representation, only a thick line is illustrated in FIG. 12, but it does not mean that there is only one bus or one type of bus.

The memory 1203 may be a read-only memory (ROM) or other types of static storage devices that can store static information and instructions, a random access memory (RAM) or other types of dynamic storage devices that can store information and instructions, or an electrically erasable programmable read-only memory (EEPROM), a compact disc read-only memory (CD-ROM) or other optical disc storage, optical disk storage (including compressed optical disk, laser disk, optical disk, digital versatile disk, Blu-ray disk, etc.), a magnetic disk storage medium or other magnetic storage devices, or any other medium that can be configured to carry or store the desired program codes in the form of instructions or data structures and can be accessed by a computer, but is not limited to these.

An example of the present disclosure provides a computer-readable storage medium, on which a computer program is stored. The computer program, when running on a computer, enables the computer to perform the corresponding contents of the foregoing method examples.

Although the steps in the flowcharts of the accompanying drawings are displayed sequentially as indicated by the arrows, it is to be understood that these steps are not necessarily performed sequentially in the order indicated by the arrows. Unless otherwise specified herein, there is no strict order limitation for performing these steps and these steps may be performed in other orders. In addition, at least part of the steps in the flowcharts of the accompanying drawings may include multiple sub-steps or multiple phases. These sub-steps or phases are not necessarily performed at the same time, but may be performed at different moments. These sub-steps or phases are not necessarily performed in the sequential order, and may be rotated or alternated with at least part of another step or sub-steps or phases of another step.

It is to be noted that the computer-readable storage medium in the present disclosure may be a computer-readable signal medium, a computer-readable storage medium or any combination of the two. The computer readable storage medium may be, for example but not limited to, an electronic, magnetic, optical, electromagnetic, infrared, or semiconductor system, apparatus, or component, or any combination thereof. More specific examples of the computer-readable storage medium may include, but are not limited to, an electrical connection having one or more conductors, a portable computer disk, a hard disk, an RAM, an ROM, an erasable programmable read-only memory (EPROM) or a flash memory, an optical fiber, a portable CD-ROM, an optical storage device, a magnetic storage device, or any suitable combination thereof. In the present disclosure, the computer-readable storage medium may be any tangible medium that contains or stores a program that may be use by or in connection with an instruction execution system, apparatus, or device. In the present disclosure, the computer-readable signal medium may include data signals propagated in a baseband or as a part of a carrier wave, in which computer-readable program codes are carried. Such the propagated data signals may take a variety of forms, including but not limited to electromagnetic signals, optical signals, or any suitable combination thereof. The computer-readable signal medium may also be any computer-readable medium other than the computer-readable storage medium, which may send, propagate, or transport the program that is use by or in connection with the instruction execution system, apparatus, or device. The program codes contained on the computer-readable medium may be transmitted via any appropriate medium, including but not limited to: a wire, an optical cable, radio frequency (RF), etc., or any suitable combination thereof.

The computer-readable medium may be included in the WLAN initiating device or responding device, or may exist independently without being equipped into the WLAN initiating device or responding device.

The computer-readable medium carries one or more programs. The one or more programs, when executed by the WLAN initiating device or responding device, enable the initiating device or the responding device to perform the corresponding communication methods.

According to one aspect of the present disclosure, a computer program product or a computer program is provided. The computer program product or the computer program includes computer instructions stored in a computer-readable storage medium. One or more processors of a computer device read the computer instructions from the computer-readable storage medium and execute the computer instructions, so that the computer device performs the communication methods provided in the various candidate implementations.

Computer program codes for performing operations of the present disclosure may be written in one or more programming languages, or a combination thereof, including object-oriented programming languages such as Java, Smalltalk, C++, and conventional procedural programming languages such as “C” or similar programming languages. The program codes may be executed entirely on a user computer, executed partly on the user computer, executed as a stand-alone software package, executed partly on the user computer and partly on a remote computer, or executed entirely on the remote computer or server. In a case involving the remote computer, the remote computer may be connected to the user computer through any type of network, including a local area network (LAN) or a wide area network (WAN), or may be connected to an external computer (for example, through the Internet of an Internet service provider).

The flowcharts and block diagrams in the accompanying drawings illustrate possible implementation architectures, functions, and operations of the systems, the methods, and the computer program products according to various examples of the present disclosure. In this respect, each box in the flowchart or block diagram may represent a module, a program segment or a portion of codes, which contains one or more executable instructions for implementing the specified logical function. It is also to be noted that, in some alternative implementations, the functions pointed by the boxes may occur out of the order pointed by the accompanying drawings. For example, two boxes shown in succession may actually be executed substantially in parallel, or may sometimes be executed in a reverse order, depending on the involved functions. It is also to be noted that each box in the block diagram and/or flowchart, and a combination of boxes in the block diagram and/or flowchart may be implemented by a dedicated hardware-based system that performs specified functions or operations, or may be implemented by a combination of dedicated hardware and computer instructions.

The modules involved in the described examples of the present disclosure may be implemented by software or by hardware. The name of a module does not, in some cases, constitute a limitation on the module itself. For example, module A may also be described as “module A for performing operation B”.

The above description is only an illustration of the preferred examples of the present disclosure and the used technical principles. Those skilled in the art should understand that the scope of disclosure involved in the present disclosure is not limited to the technical solutions formed by specific combinations of the above technical features, but should also cover other technical solutions formed by any combination of the above technical features or their equivalent features without departing from the disclosure concepts, for example, the technical solutions formed by replacing the above features and, but not limited to, the technical features having similar functions disclosed in the present disclosure with each other.

1. A method for wireless communication performed by a sensing by proxy (SBP) responding device, the method comprising:
receiving a first message frame, wherein the first message frame indicates that an SBP report frame is to be transmitted; and
transmitting the SBP report frame.

2. The method according to claim 1, wherein the first message frame is a clear to send (CTS)-to-self frame, a power save (PS)-Poll frame or an SBP report request frame.

3. The method according to claim 2, wherein first message frame is the CTS-to-self frame and the method further comprises:
transmitting a poll frame, wherein the poll frame requests a trigger for transmitting the SBP report frame.

4. The method according to claim 2, wherein the first message frame is the PS-Poll frame and the method further comprises:
transmitting a second message frame, wherein the second message frame indicates a confirmation of transmitting the SBP report frame.

5. The method according to claim 4, wherein the second message frame is a null frame or an acknowledgment (ACK) frame.

6. The method according to claim 2, wherein the first message frame is the SBP report request frame, and the first message frame comprises a wireless local area network (WLAN) sensing measurement setup identifier allocated by the SBP responding device to an SBP initiating device.

7. The method according to claim 1, wherein the SBP report frame comprises a wireless local area network (WLAN) sensing measurement setup identifier allocated by the SBP responding device to an SBP initiating device.

8. The method according to claim 1, wherein transmitting the SBP report frame comprises:
transmitting the SBP report frame within a first time interval, wherein the first time interval is determined by the SBP responding device and an SBP initiating device in a wireless local area network (WLAN) sensing measurement setup procedure.

9. The method according to claim 1, wherein the SBP report frame comprises sensing measurement results of all station devices (STAs) participating in a wireless local area network (WLAN) sensing measurement in a case that an SBP initiating device does not participate in the WLAN sensing measurement, and does not comprise the sensing measurement result of the SBP initiating device in a case that the SBP initiating device participates in the WLAN sensing measurement.

10. A method for wireless communication performed by a sensing by proxy (SBP) initiating device, the method comprising:
transmitting a first message frame, wherein the first message frame indicates that an SBP report frame is to be transmitted; and
receiving the SBP report frame.

11. The method according to claim 10, wherein the first message frame is a clear to send (CTS)-to-self frame, a power save (PS)-Poll frame or an SBP report request frame.

12. The method according to claim 11, wherein when the first message frame is the CTS-to-self frame and frame, the method further comprises:
receiving a poll frame, wherein the poll frame requests a trigger for transmitting the SBP report frame.

13. The method according to claim 11, wherein when the first message frame is the PS-Poll frame and the method further comprises:
receiving a second message frame, wherein the second message frame indicates a confirmation of transmitting the SBP report frame.

14. The method according to claim 13, wherein the second message frame is a null frame or an acknowledgment (ACK) frame.

15. The method according to claim 11, wherein the first message frame is the SBP report request frame, and the first message frame comprises a wireless local area network (WLAN) sensing measurement setup identifier allocated by an SBP responding device to the SBP initiating device.

16. The method according to claim 10, wherein the SBP report frame comprises a wireless local area network (WLAN) sensing measurement setup identifier allocated by an SBP responding device to the SBP initiating device.

17. The method according to claim 10, wherein receiving the SBP report frame comprises:
receiving the SBP report frame within a first time interval, wherein the first time interval is determined by an SBP responding device and the SBP initiating device in a wireless local area network (WLAN) sensing measurement setup procedure.

18. The method according to claim 10, wherein the SBP report frame comprises sensing measurement results of all station devices (STA) participating in a wireless local area network (WLAN) sensing measurement in a case that the SBP initiating device does not participate in the WLAN sensing measurement, and does not comprise the sensing measurement result of the SBP initiating device in a case that the SBP initiating device participates in the WLAN sensing measurement.

19-20. (canceled)

21. A sensing by proxy (SBP) responding device, comprising:
one or more memories,
one or more processors, and
a computer program stored in the one or more memories and executable on the one or more processors,
wherein the computer program, when collectively executed by the one or more processors, cause the SBP responding device to:
receive a first message frame, wherein the first message frame indicates that an SBP report frame is to be transmitted; and
transmit the SBP report frame.

22. A sensing by proxy (SBP) initiating device, comprising:
one or more memories,
one or more processors, and
a computer program stored in the one or more memories and executable on the one or more processors,
wherein the computer program, when collectively executed by the one or more processors cause the electronic device to act as the SBP initiating device and perform the method according to claim 10.

23. (canceled)
